(19) United States
(12) Patent Application Publication
(10) Pub. No.: US 2013/0286966 A1
(43) Pub. Date: Oct. 31, 2013

(54) METHOD OF ALLOCATING RADIO RESOURCES FOR CONTROL CHANNEL AND METHOD FOR RECEIVING THE CONTROL CHANNEL

(71) Applicant: Electronics and Telecommunications Research Institute, (US)

(72) Inventors: Hee Sang CHUNG, Daejeon (KR); Jun Hwan LEE, Seoul (KR); Il Gyu KIM, Chungcheongbuk-do (KR); Seung Chan BANG, Daejeon (KR)

(73) Assignee: Electronics and Telecommunications Research Institute, Daejeon (KR)

(21) Appl. No.: 13/871,599

(22) Filed: Apr. 26, 2013

(30) Foreign Application Priority Data
Apr. 27, 2012 (KR) 10-2012-0044461
Oct. 31, 2012 (KR) 10-2012-0122366

(51) Int. Cl. H04W 72/04

(52) U.S. Cl. CPC H04W 72/0406
USPC 370/329

(57) ABSTRACT

A method and apparatus for allocating radio resources for a control channel, and a method of receiving the control channel are disclosed. According to an aspect, the method of allocating radio resources includes: recognizing one or more reference signals included in an enhanced control channel positioned in a resource region for downlink data; dynamically setting a resource element group including one or more resource elements that are to be allocated to the enhanced control channel, according to the one or more reference signals; and determining one or more resource elements available for the enhanced control channel among the resource elements included in the set resource element group, and allocating the one or more resource elements to the enhanced control channel.

### CLAIM FOR PRIORITY

This application claims priority to Korean Patent Applications No. 2012-0044461 filed on Apr. 27, 2012 and No. 2012-0122366 filed on Oct. 31, 2012 in the Korean Intellectual Property Office (KIPO), the entire contents of which are hereby incorporated by reference.

### BACKGROUND

1. Technical Field

Example embodiments of the present invention relate in general to a method of allocating radio resources for a control channel, and a method for receiving the control channel, and more particularly, to a method and apparatus for allocating radio resources for a control channel, and a method of receiving the control channel.

2. Related Art

In Long Term Evolution (LTE) and LTE-Advanced (LTE-A) mobile communication methods, related control information is needed to support transmission of downlink and uplink transfer channels. In an LTE/LTE-A system, generally, one through four orthogonal frequency division multiplexing (OFDM) symbols can be used for a control channel for transferring such control information.

A control channel occupies one through four OFDM symbols located in the head of a 1 ms subframe in the time domain. The control channel occupies the entire system band in the frequency domain. For example, in the case of a system using a frequency band of 10 MHz, the control channel ranges over the entire frequency band of 10 MHz.

The 3^{rd} Generation Partnership Project (3GPP) Release 8/Release 9 relates to LTE technology, and the 3GPP Release 10 relates to LTE-A technology. In the 3GPP Release 11, which is currently in progress, introduction of a new type of control channel is being considered in order to overcome the limitation of conventional control channels, and studies into such a new type of control channel known as an enhanced control channel are being conducted. Particularly, studies into an enhanced control channel known as an enhanced physical downlink control channel (E-PDCCH or e-PDCCH) compared to PDCCH according to the existing Release are mainly conducted.

In order to efficiently introduce the concept of such an enhanced control channel in a mobile communication system, a resource allocation unit (for example, a resource element group (REG)), a modulation method, etc. that have been applied to the conventional control channel should be modified.

### SUMMARY

Accordingly, example embodiments of the present invention are provided to substantially obviate one or more problems due to limitations and disadvantages of the related art.

Example embodiments of the present invention provide a radio resource allocation method suitable for a radio frame structure configured in consideration of an enhanced control channel.

Example embodiments of the present invention also provide a base station for allocating resources using the radio resource allocation method.

Example embodiments of the present invention also provide a method in which a terminal receives control information configured by the radio resource allocation method. In some example embodiments, a method of allocating radio resources in a mobile communication system includes: recognizing one or more reference signals included in an enhanced control channel positioned in a resource region for downlink data; dynamically setting a resource element group including one or more resource elements that are to be allocated to the enhanced control channel, according to the one or more reference signals; and determining one or more resource elements available as the enhanced control channel among the resource elements included in the set resource element group, and allocating the one or more resource elements to the enhanced control channel.

The resource element group may include 4, 6, 8, or 12 resource elements.

The resource element group may include one or two orthogonal frequency division multiplexing (OFDM) symbols that are consecutive in a time domain.

The reference signals may include at least one signal among a cell-specific reference signal, a demodulation reference signal, and a channel state information-reference signal.

Dynamically setting the resource element group may include allocating the resource elements included in the resource element group to the enhanced control channel depending on the numbers and positions of the reference signals included in the resource element group. If a normal cyclic prefix (CP) is used in a frame in which the resource element group is included, the resource element group may include 4, 6, or 8 resource elements. Dynamically setting the resource element group may include setting a resource element group including 8 resource elements if a corresponding symbol includes a demodulation reference signal.

If a normal cyclic prefix (CP) is used in a frame in which the resource element group is included, the resource element group may include 4, 6, or 12 resource elements. A resource element group including 6 or 12 resource elements may be set if a corresponding symbol includes a demodulation reference signal.

Dynamically setting the resource element group may include setting a resource element group including 4 or 6 resource elements if a corresponding symbol includes a reference signal other than a demodulation reference signal.

If the resource element group includes 8 resource elements, the resource element group may include two symbols that are consecutive in a time domain.

If the resource element group includes 4, 6, or 12 resource elements, the resource element group may include one symbol in a time domain.

Determining the one or more resource elements available as the enhanced control channel and allocating the one or more resource elements to the enhanced control channel may include: matching, if the number of available resource elements excluding resource elements in which the one or more reference signals included in the resource element group are positioned is 4 or more, the available resource elements with a resource element pattern of one or more resource element patterns; and allocating the available resource elements to the enhanced control channel according to the matched resource element pattern.

In other example embodiments, a base station includes: a radio resource allocating unit configured to recognize one or more reference signals included in an enhanced control channel positioned in a resource region for downlink data, to dynamically set a resource element group including one or more resource elements that are to be allocated to the enhanced control channel, according to the one or more reference signals, to determine one or more resource elements available as the enhanced control channel among the resource elements included in the set resource element group, and to allocate the one or more resource elements to the enhanced control channel; a frame configuring unit configured to configure a frame according to the allocated resource elements; and a radio transmitter configured to transmit the frame.

The radio resource allocating unit may allocate the resource elements included in the resource element group to the enhanced control channel depending on the numbers and positions of the reference signals included in the resource element group.

In other example embodiments, a method in which a terminal receives control information from a base station includes: receiving a radio frame transmitted from the base station; defining at least one resource element group included in the radio frame; recognizing one or more resource elements for a control channel, in consideration of one or more reference signals included in the resource element group; and acquiring control information from the one or more resource elements for the control channel.

The resource element group may include 4, 6, 8, or 12 resource elements.

Therefore, according to the embodiments as described above, it is possible to effectively allocate resources in a radio frame structure in which an enhanced control channel is considered.

Also, since the concepts of CCE and aggregation level can be used by setting a basic unit for resource allocation to eREG, the concept used in the existing control channel can be reused.

### BRIEF DESCRIPTION OF DRAWINGS

Example embodiments of the present invention will become more apparent by describing in detail example embodiments of the present invention with reference to the accompanying drawings, in which:

FIG. 1 shows a subframe structure including a normal cyclic prefix (CP), which is used in a mobile communication system;

FIG. 2 is a conceptual view of resource element groups (REGs) configuring control channels;

FIG. 3 shows a downlink frame structure for a mobile communication system, configured in consideration of an enhanced physical downlink control channel (ePDCCH);

FIG. 4 is a conceptual view of conventional REGs and eREGs extended from the conventional REGs;

FIG. 5 is a conceptual view of additional eREG patterns according to another embodiment of the present invention;

FIG. 6 is a conceptual view of additional eREG patterns according to another embodiment of the present invention;

FIG. 7 shows a resource pattern to which ePDCCH is applied, according to an embodiment of the present invention;

FIG. 8 is a view for explaining the concept of resource allocation in which eREGs are applied to case 1, according to an embodiment of the present invention;

FIG. 9 is a view for explaining the concept of resource allocation in which eREGs are applied to case 1, according to another embodiment of the present invention;

FIG. 10 shows a resource pattern to which ePDCCH is applied, according to another embodiment of the present invention, wherein channel state information-reference signals (CSI-RSs) are added to the resource pattern shown in FIG. 7;

FIG. 11 is a view for explaining the concept of resource allocation in which eREGs are applied to case 2, according to an embodiment of the present invention;

FIG. 12 is a view for explaining the concept of resource allocation in which eREGs are applied to case 2, according to another embodiment of the present invention;

FIG. 13 shows a resource pattern to which ePDCCH is applied, according to another embodiment of the present invention;

FIG. 14 is a view for explaining the concept of resource allocation in which eREGs are applied to case 3, according to an embodiment of the present invention;

FIG. 15 shows a resource pattern to which ePDCCH is applied, according to an embodiment of the present invention, wherein an extended CP is used;

FIG. 16 is a view for explaining the concept of resource allocation in which eREGs are applied to case 4, according to an embodiment of the present invention;

FIG. 17 shows a resource pattern to which ePDCCH is applied, according to an embodiment of the present invention, wherein an extended CP is used;

FIG. 18 is a view for explaining the concept of resource allocation in which eREGs are applied to case 5, according to an embodiment of the present invention;

FIG. 19 shows a resource pattern to which ePDCCH is applied, according to another embodiment of the present invention, wherein an extended CP is used;

FIG. 20 is a view for explaining the concept of resource allocation in which eREGs are applied to case 6, according to an embodiment of the present invention;

FIG. 21 is a table showing symbol indexes of CRSs with respect to antenna configuration and CP types;

FIG. 22 shows REGs for individual symbols that can be applied when a normal CP is used in a frequency division duplex (FDD) frame structure;

FIG. 23 shows REGs for individual symbols, which can be applied when an extended CP is used in an FDD frame structure;

FIG. 24 shows various REG patterns according to antenna ports;

FIGS. 25 through 27 are conceptual views of additional eREG patterns according to other embodiments of the present invention;

FIG. 28 shows an embodiment of resource allocation in eREGs each including 12 REs;

FIG. 29 is a flowchart showing a radio resource allocation method according to an embodiment of the present invention;

FIG. 30 is a flowchart showing a method in which a terminal receives control information according to an embodiment of the present invention; and

FIG. 31 is a block diagram of a base station according to an embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “terminal” may refer to a mobile station (MS), user equipment (UE), user terminal (UT), wireless terminal, access terminal (AT), subscriber unit, subscriber station (SS), wireless device, wireless communication device, wireless transmit/receive unit (WTRU), moving node, mobile, or other terms. Various exemplary embodiments of a terminal may include a cellular phone, a smart phone having a wireless communication function, a personal digital assistant (PDA) having a wireless communication function, a wireless modem, a portable computer having a wireless communication function, a photographing apparatus such as a digital camera having a wireless communication function, a gaming apparatus having a wireless communication function, a music storing and playing appliance having a wireless communication function, an Internet home appliance capable of wireless Internet access and browsing, and also portable units or terminals having a combination of such functions, but are not limited to these.

In this specification, the term “cell” or “base station” means a fixed or movable point that communicates generally with terminals, and may include a base station, a Node-B, an eNode-B, a base transceiver system (BTS), an access point, a relay, a femto-cell, or the like.

Hereinafter, embodiments of the present invention will be described in detail with reference to the appended drawings. In the following description, for easy understanding, like numbers refer to like elements throughout the description of the figures, and the same elements will not be described further.

For easy understanding, a physical downlink control channel (PDCCH) that has been conventionally used as a downlink control channel will be first described, below.

The PDCCH will be mentioned as a legacy PDCCH for comparison to an enhanced PDCCH (ePDCCH) that will be discussed in this specification.

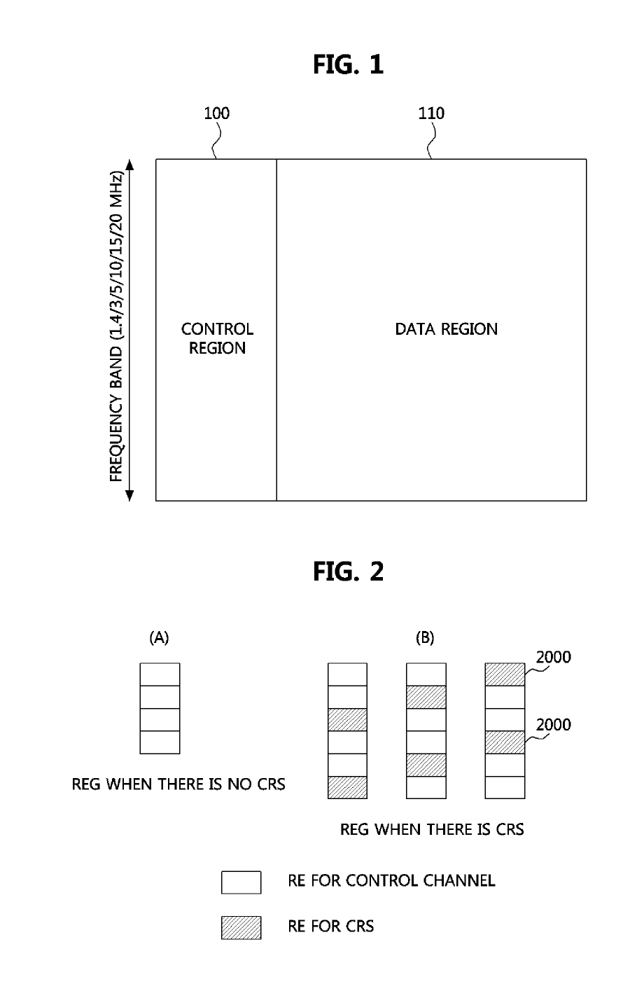

FIG. 1 shows a subframe structure including a normal cyclic prefix (CP), which is used in a mobile communication system.

In Long Term Evolution (LTE)/LTE-Advanced (LTE-A), physical resources are represented basically as time-frequency resources. In FIG. 1, the vertical axis represents a frequency, and LTE/LTE-A supports 6 bandwidths of 1.4/3/5/10/15/20 MHz. The horizontal axis of FIG. 1 represents a time, and when the subframe structure includes a cyclic prefix, a total of 14 orthogonal frequency division multiplexing (OFDM) symbols occupy a time period of 1 ms.

In a legacy control region, control channels of a physical control format indicator channel (PCFICH), a physical hybrid-ARQ indicator channel (PHICH), etc. are multiplexed in addition to a PDCCH. A data region includes physical channels, such as a physical downlink shared channel (PDSCH), a physical broadcast channel (PBCH), etc.

The legacy PDCCH, as shown in FIG. 1, extends through the entire frequency band, and may occupy 1 through 4 OFDM symbols in the head of each subframe in the time domain.

FIG. 2 is a conceptual view for resource element groups (REGs) configuring control channels.

An LTE/LTE-A resource element (simply referred to as an RE) corresponds to an OFDM subcarrier for an OFDM symbol period, and a plurality of REs may configure an REG.

An REG may be configured to include 4 or 6 REs according to presence/absence of REs for cell-specific reference signals (CRSs).

If there is no CRS, an REG includes 4 REs as shown in (a) of FIG. 2.

If there are CRSs, an REG may include 6 REs. If an REG includes 6 REs, there may be three REG patterns according to the arrangement of CRSs, as shown in (b) of FIG. 2.

In any of the cases (a) and (b) of FIG. 2, 4 REs are provided for a control channel in an REG. Since symbols resulting from modulating PDCCH data are processed in units of quadruplets, using 4 REs facilitates resource allocation. 9 REGs each configured as described above configure a control channel element (CCE).

A PDCCH for LTE/LTE-A may be configured to include 1 CCE, 2 CCEs, 4 CCEs, or 8 CCEs. In a cell region having a sufficiently high signal-to-interference plus noise ratio (SINR), a PDCCH configured with 1 or 2 CCEs is used. However, in a region having a low SINR, such as a cell edge, a PDCCH configured with 4 or 8 CCEs is transmitted for stable operation of a control channel.

In view of a modulation method, the legacy PDCCH uses only a quadrature phase shift keying (QPSK) method. Also, a transmission mode is limited to a single antenna scheme or a transmit diversity scheme. For an ePDCCH, 16QAM which is a high order modulation scheme is considered, and as a transmission mode, beamforming or a multi-user multi input multi output (MIMO) scheme is considered.

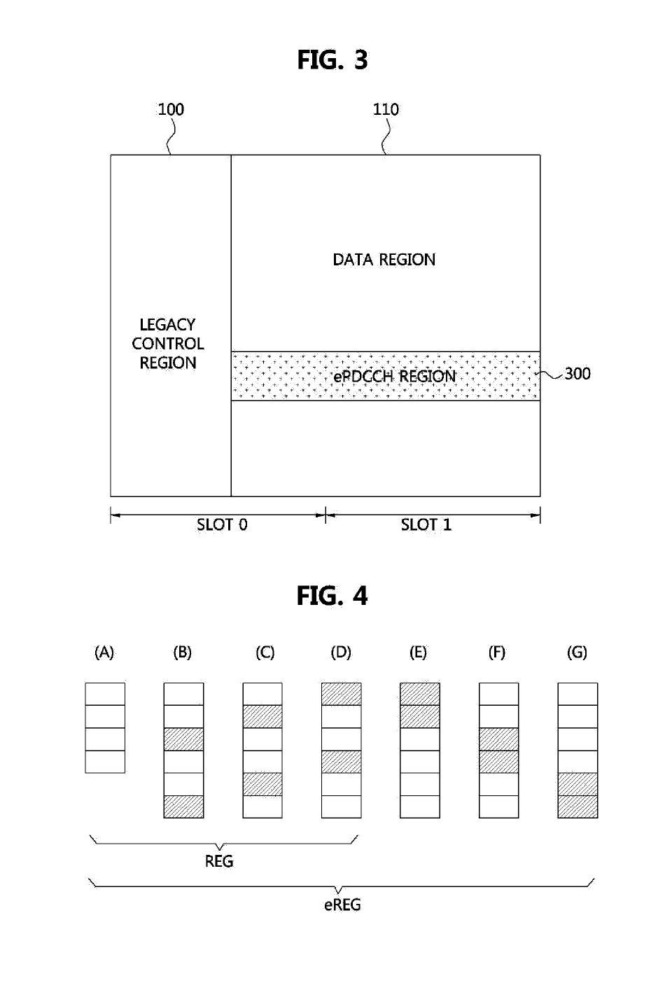

FIG. 3 shows a downlink frame structure for a mobile communication system, configured in consideration of an ePDCCH.

That is, FIG. 3 shows a downlink frame structure in which an ePDCCH is added to a conventional frame structure for LTE/LTE-A.

An ePDCCH has been designed for the purposes of an increase in control channel capacity, interference cancellation in the frequency domain, improvement of spatial reuse, beamforming, etc.

In order to achieve the purposes, techniques that have been applied to a PDSCH which is a conventional data channel have to be used. Accordingly, an ePDCCH region has been added to the data region outside of the legacy control region.

If the frame structure as shown in FIG. 3 is used, a legacy terminal using a conventional standard can use the legacy control region. Also, a terminal using a new standard may use the ePDCCH region 300, as well as the legacy control region, when there is a demand for an additional control channel or other needs. Also, a MIMO transmission mode, beamforming, etc. that have been applied to conventional data channels may be additionally applied.

However, the ePDCCH region 300 occupies a narrow area in the frequency domain, but a wide area in the time domain, compared to the legacy control region. Accordingly, resource allocation in ePDCCH is different from resource allocation in the legacy region.

For this reason, the present disclosure proposes a resource allocation method that is effective for the resource structure of ePDCCH.

Legacy PDCCH is allocated to a separate OFDM symbol region only for a control channel. Accordingly, when an REG is configured in a legacy PDCCH region, it is first determined whether or not the corresponding one among OFDM symbols considered for configuration of an REG is a resource for PCFICH or PHICH. With regard to an OFDM symbol which is not a resource for PCFICH or PHICH, it is determined whether to configure an REG with 4 REs or with 6 REs depending on presence/absence of CRSs.

In contrast, ePDCCH is allocated to a data region. In the data region, PDSCH which is a data channel, PBCH which is a broadcast channel, primary synchronization signals (PSSs) and secondary synchronization signals (SSSs), which are synchronization signals, and various reference signals (RSs) are allocated.

According to an embodiment of the present invention, an ePDCCH may be allocated to a different frequency region from frequency regions to which a PDSCH, a PSS, an SSS, etc. are allocated so that the frequency regions do not overlap. Accordingly, for resource allocation in an ePDCCH, how to process various RSs should be considered.

The data region may include various RSs, such as demodulation reference signals (DMRSs), channel state information-reference signals (CSI-RSs), etc., in addition to CRSs. The CRSs may be arranged depending on the number of antennas which a base station uses. That is, CRSs are arranged in consideration of the configuration of one antenna, two antennas, or four antennas, and the legacy PDCCH has been designed in consideration of the arrangement of CRSs depending on the number of antennas. Likewise, an ePDCCH should also be designed in consideration of the arrangement of CRSs.

In which OFDM symbol a PDCCH should be arranged depends on the length of the corresponding CP, and the legacy PDCCH has also been designed in consideration of the length of the CP.

As CPs that are used in an LTE/LTE-A mobile communication system, two types of a normal CP and an extended CP have been defined. A normal CP includes 7 OFDM symbols for each slot, and an extended CP includes 6 OFDM symbols for each slot.

Two CP lengths are defined in the LTE/LTE-A mobile communication system because a long CP is inefficient in view of CP overhead, but effective in a specific environment such as a very large cell in which signals are spread with a great delay spread in the time domain. However, even in the case of a cell having a very great delay spread, a long CP is not always efficient. If the performance of a link is limited due to noise rather than signal impairments due to a remaining delay spread not removed due to the shorter length of a CP than a delay spread, acquiring additional robustness against a delay spread by increasing the length of a CP is not efficient. This is because the energy of a reception signal is reduced as the length of a CP increases.

Also, in the case of a multicast broadcast signal frequency network (MBSFN) mode, an extended CP is often used. In the case of multicast/broadcast transmission based on the MBSFN, time delay differences of signal reception from a plurality of cells participating in MBSFN transmission, as well as time delay in an actual channel should be considered for a CP.

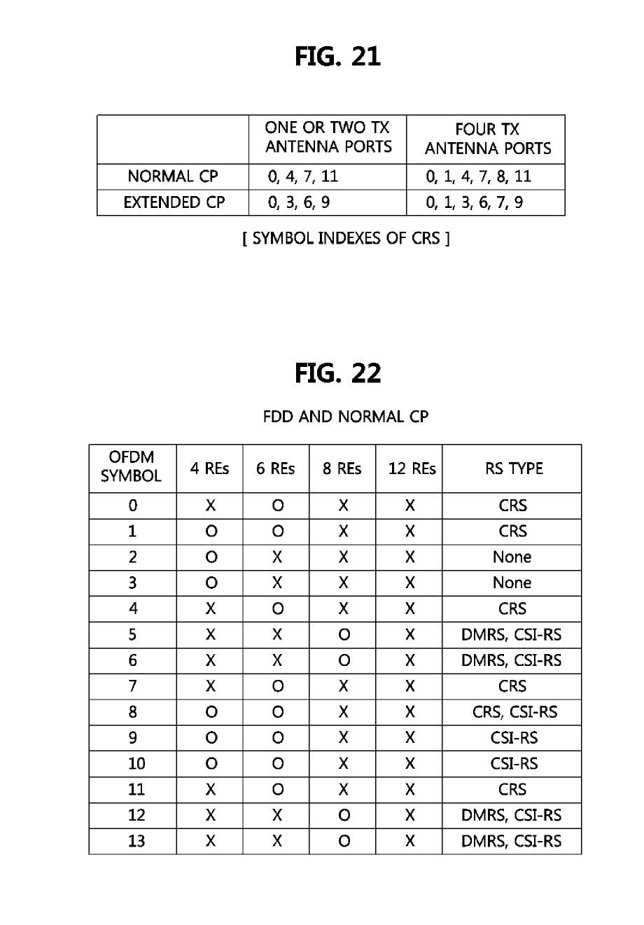

FIG. 21 is a table showing symbol indexes of CRSs with respect to antenna configuration and CP types.

Since a subframe includes two slots, the indexes of OFDM symbols that occupy the subframe are 0, 1, . . . , 13 in the case of a normal CP, and 0, 1, . . . , 11 in the case of an extended CP.

In the case of the normal CP, if one or two transmission antenna ports are provided, CRSs are positioned at the symbol indexes 0, 4, 7, and 11, and if four transmission antenna ports are provided, CRSs are positioned at the symbol indexes 0, 1, 4, 7, 8, and 11.

In the case of the extended CP, if one or two transmission antenna ports are provided, CRSs are positioned at the symbol indexes 0, 3, 6, and 9, and if four transmission antenna ports are provided, CRSs are positioned at the symbol indexes 0, 1, 3, 6, 7, and 9.

Hereinafter, several embodiments of eREG according to the present invention will be described.

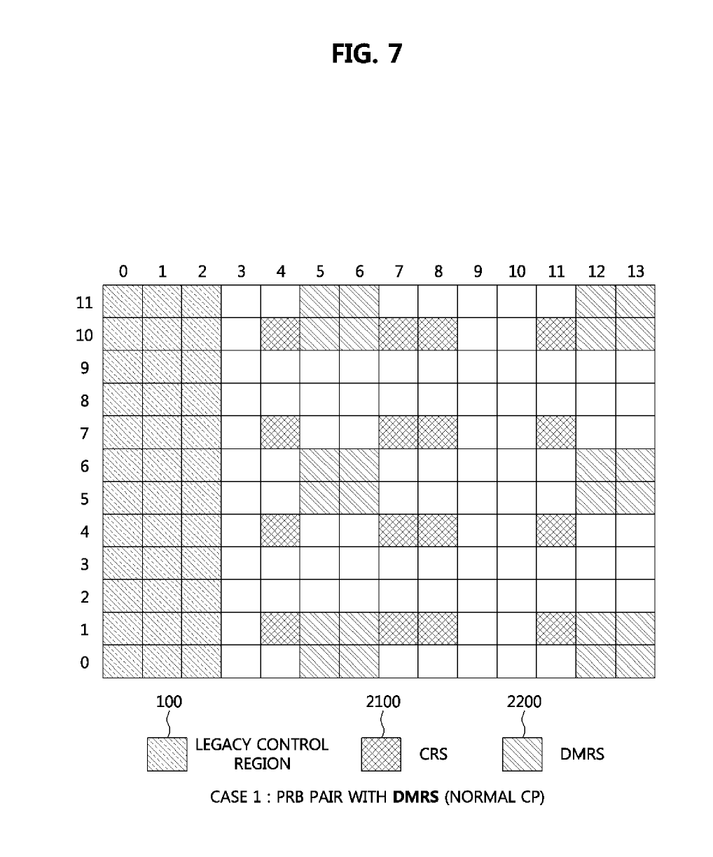

FIG. 7 is a frame configuration diagram of legacy control regions, CRSs, and DMRSs in a pair of physical resource blocks (PRBs).

In the frame configuration of FIG. 7, indexes 0 through 11 of the vertical axis are frequency units and represent 12 subcarriers, and indexes 0 through 13 of the horizontal axis represent symbol indexes when 14 OFDM symbols are provided for a time period of 1 ms.

In the resource region shown in FIG. 7, remaining regions except for the legacy control regions and the DMRS and CRS regions can be allocated for ePDCCH. A CRS is transmitted for each downlink subframe over the entire bandwidth of a downlink cell. A CRS is used in channel estimation for coherent demodulation of downlink transmission, except when a beamforming technique not based on a codebook is used. Meanwhile, DMRSs and CSI-RSs may have various patterns compared to CRSs.

Excluding the OFDM symbols 0 through 2 corresponding to the legacy control regions 100, a total of 11 OFDM symbols from 3 to 13 may be used for ePDCCH. The conventional REG concept may be applied to the symbols 4, 7, 8, and 11 since the symbols 4, 7, 8, and 11 include CRSs 2100.

That is, the symbols 4, 7, 8, and 11 each include two REGs when each symbol is divided in units of REGs configured with 6 REs as shown in FIG. 2. Also, the symbols 5, 6, 12, and 13 need to be allocated resources in consideration of DMRSs, and accordingly, resource allocation for an ePDCCH based on the conventional REG concept is not easy because of the DMRS patterns.

In detail, FIG. 7 relates to the case in which four DMRS antenna ports (antennas 7, 8, 9, and 10) are provided, and the conventional REG concept cannot be applied to the OFDM symbols 5, 6, 12, and 13 since the 6 REs of each OFDM symbol are occupied by DRMSs which are reference signals. That is, if 4 REs configure an REG, only 2 REs for each REG may be available. Meanwhile, if 6 REs configure an REG, only 3 REs for each REG may be available. Accordingly, the conventional REG concept of allocating resources in units of 4 REs cannot be maintained.

According to the present invention, an eREG which is the extended concept of an REG is introduced to facilitate resource allocation in the PDCCH region as described above. That is, in a data region PDSCH, resource allocation for an ePDCCH may be performed in consideration of CRSs, DMRSs, and CSI-RSs.

FIG. 4 is a conceptual view of conventional REGs and eREGs extended from the conventional REGs.

(a) through (d) of FIG. 4 show conventional REGs configured with 4 or 6 REs, and (e) through (g) of FIG. 4 show three additional patterns for eREGs. (e) through (g) of FIG. 4 are patterns each configured with 6 REs, like (b) through (d) of FIG. 4, but in which 2 REs are occupied by CSI-RSs. In summary, eREGs include new patterns (three additional patterns in FIG. 4) in addition to existing REG patterns.

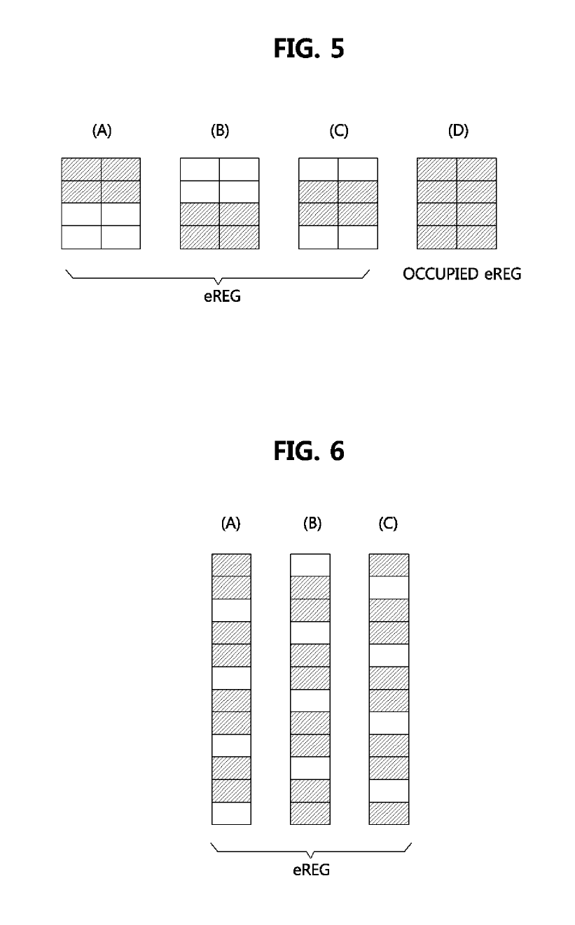

FIG. 5 is a conceptual view of additional eREG patterns according to another embodiment of the present invention.

As shown in FIG. 5, an eREG pattern can have 8 REs configuring two consecutive OFDM symbols, unlike the existing REG.

(a) through (c) of FIG. 5 correspond to eREGs in which when 4 REs among 8 REs are occupied by RSs, the remaining 4 REs can be used as ePDCCH resources. (d) of FIG. 5 cannot be used as an ePDCCH resource since 8 REs are all occupied by RSs, however, it is also classified as an eREG (specifically, an occupied eREG) since it can be used for seamless resource allocation. The cases having more than 8 REs will be described later.

FIG. 6 is a conceptual view of additional eREG patterns according to another embodiment of the present invention.

According to the eREG patterns shown in FIG. 6, each eREG is configured with 12 REs, and 8 REs among the 12 REs are occupied by RSs so that only the remaining 4 REs can be used as ePDCCH resources. However, there may be more various modifications, and a detailed description thereof will be given later.

As such, by using the eREG patterns as shown in FIGS. 4 through 6, it is possible to facilitate resource allocation of an ePDCCH that is defined in a data region.

Hereinafter, various embodiments of resource allocation for an ePDCCH in predetermined cases, using eREG patterns according to the present invention will be described.

In order to describe various embodiments of resource allocation for an ePDCCH, in FIGS. 7 through 20, it is assumed that a legacy PDCCH is allocated to 3 OFDM symbols. However, the number of OFDM symbols to which the legacy PDCCH is allocated may be set to 1, 2, or 4.

FIG. 7 shows a resource pattern to which an ePDCCH is applied according to an embodiment of the present invention.

The resource pattern shown in FIG. 7 includes a normal CP, and a total of 14 OFDM symbols are included in a pair of PRBs. Symbols 4, 7, 8, and 11 include CRSs, and symbols 5, 6, 12, and 13 include DMRSs. The case shown in FIG. 7 is referred to as case 1.

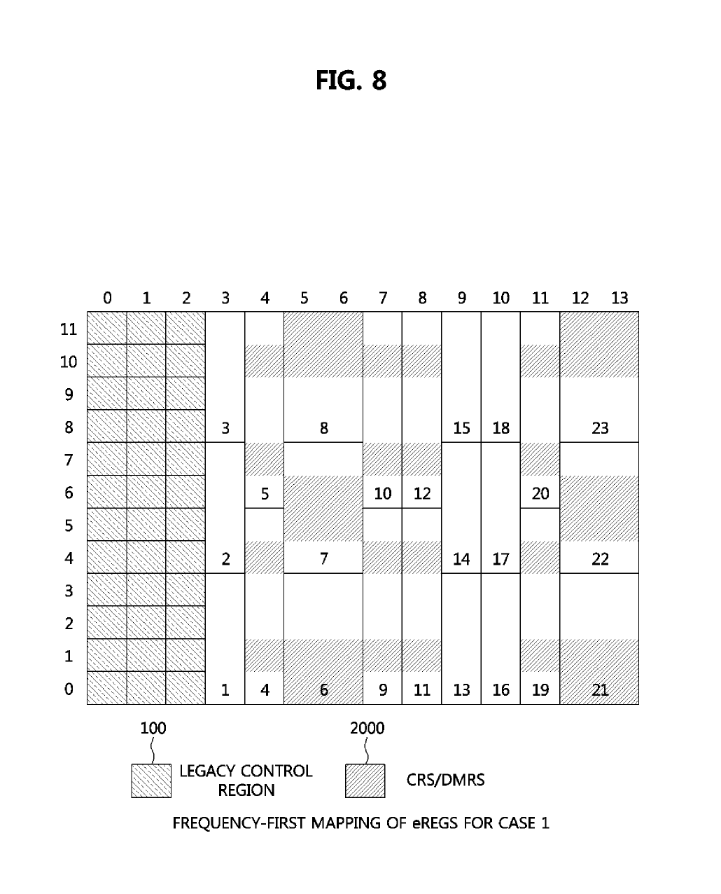

FIG. 8 is a view for explaining the concept of resource allocation in which eREGs are applied to case 1, according to an embodiment of the present invention.

It is seen from FIG. 8 that the number of eREGs available for a PDCCH is 23 when the eREG patterns shown in FIGS. 4 and 5 are used. The number of REs available for an ePDCCH included in the 23 eREGs is 92. Meanwhile, if the REG concept is applied instead of the eREG concept, the REs of the symbols 5, 6, 12, and 13 cannot be used.

In other words, if eREGs are not used, 24 REs will be wasted, but eREGs enable all symbols to be used for the ePDCCH.

Meanwhile, in order to allocate numbers for identifying the eREGs, a method of selecting an OFDM symbol having the smallest index number to preferentially map a lower frequency to the OFDM symbol and then performing frequency mapping for an OFDM symbol having the next smallest index number after completing frequency mapping for the OFDM symbol having the smallest index number is used. The method may be referred to as frequency-first mapping.

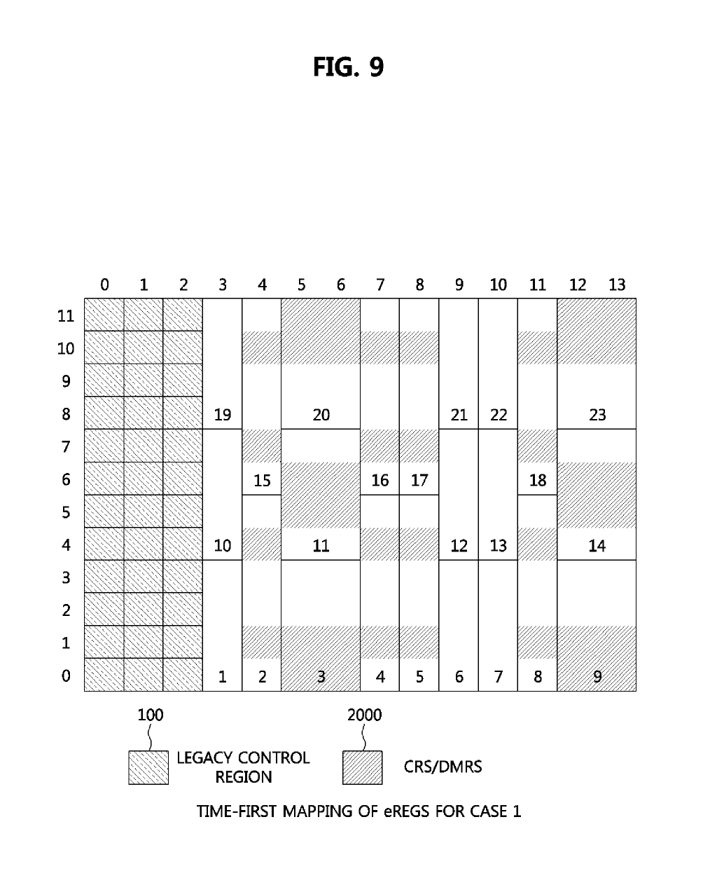

FIG. 9 is a view for explaining the concept of resource allocation in which eREGs are applied to case 1, according to another embodiment of the present invention.

The embodiment of FIG. 9 uses the same method of mapping eREG regions as that used in the embodiment of FIG. 8, but uses a different method of mapping numbers for identifying eREGs from that used in the embodiment of FIG. 8. That is, a method of preferentially mapping a lower frequency to OFDM symbols in the ascending order of the OFDM symbol numbers is used. After the frequency is completely allocated, the next lower frequency is allocated in the order of the start locations of eREGs (that is, starting from an RE corresponding to the lowest frequency and the smallest OFDM symbol number in the corresponding eREG). The method is referred to as time-first mapping. The legacy PDCCH allocates REGs according to the time-first mapping.

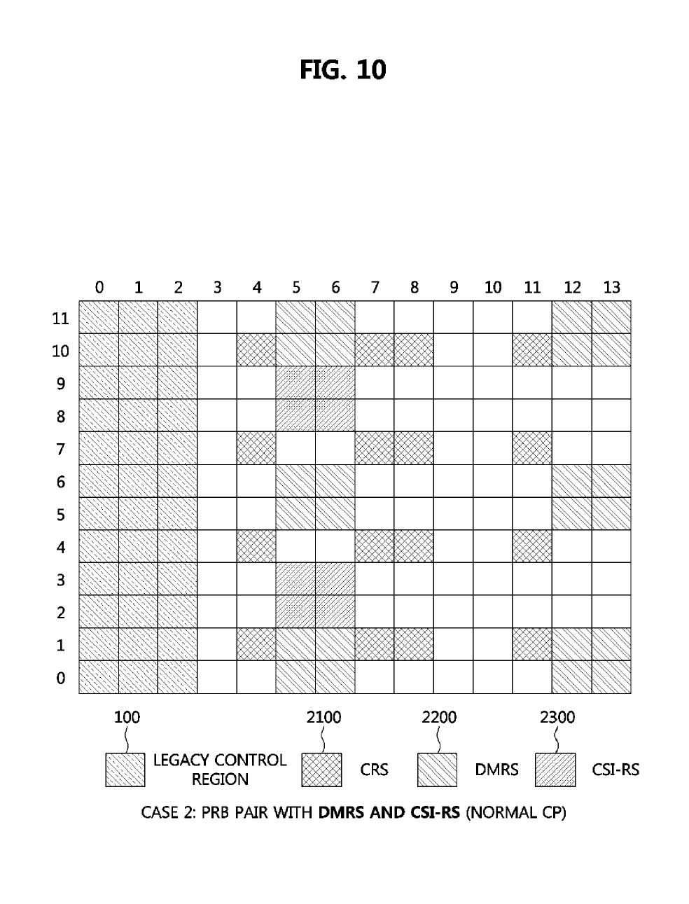

FIG. 10 shows a resource pattern to which an ePDCCH is applied according to another embodiment of the present invention, wherein CSI-RSs are added to the resource pattern shown in FIG. 7.

Since the resource pattern shown in FIG. 7 has been referred to as case 1, the resource pattern shown in FIG. 10 is referred to as case 2. In case 2 shown in FIG. 10, OFDM symbols 5 and 6 include CSI-RSs 2300 in addition to DMRSs 2200.

The DMRS 2200 which used to be a normal UE specific signal in rel.8 is a UE-specific reference signal based on non-codebook, and supports a dual layer using two symbols based on code division multiplexing (CDM) for a specific terminal in rel.9. The DMRS 2200 is used only for demodulation, and requires a complementary RS for measurement.

The CSI-RS 2300 is a separate reference signal which is different from the existing CRS, and is used for estimation of CSI, such as CQI/PMI/RI, etc. The CSI-RS 2300 is cell-specific and configured by a radio resource control (RRC) signal of a terminal.

The pattern (d) of FIG. 5, along with the patterns (a), (b), and (c) of FIG. 5, is applied to case 2 shown in FIG. 10.

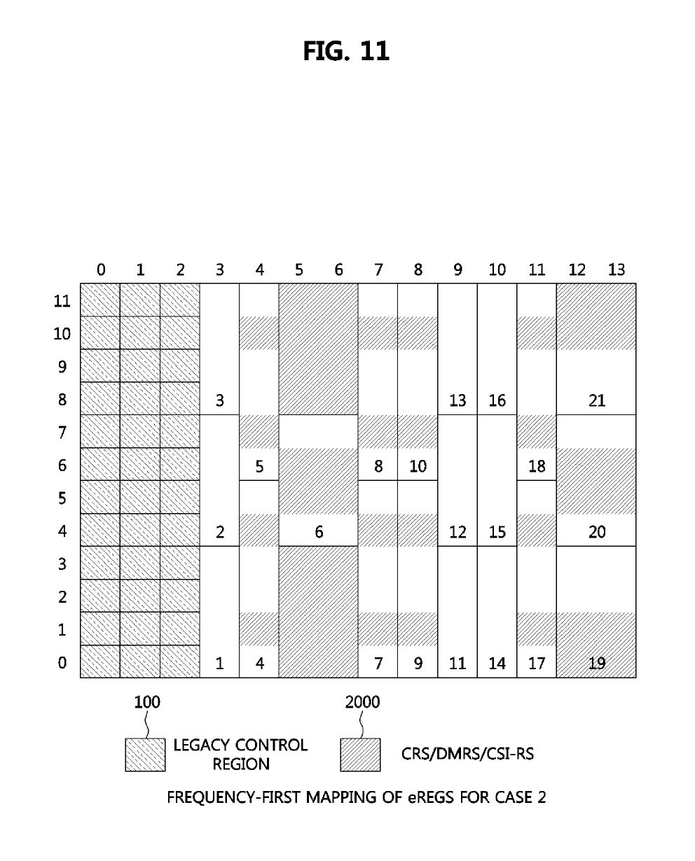

FIG. 11 is a view for explaining the concept of resource allocation in which eREGs are applied to case 2, according to an embodiment of the present invention;

As shown in FIG. 11, since unavailable eREGs are created above and below an eREG 6, a total of 21 eREGs, unlike case 1, may be used for an ePDCCH. FIG. 11 corresponds to an example in which frequency-first mapping is applied to allocate numbers to eREGs.

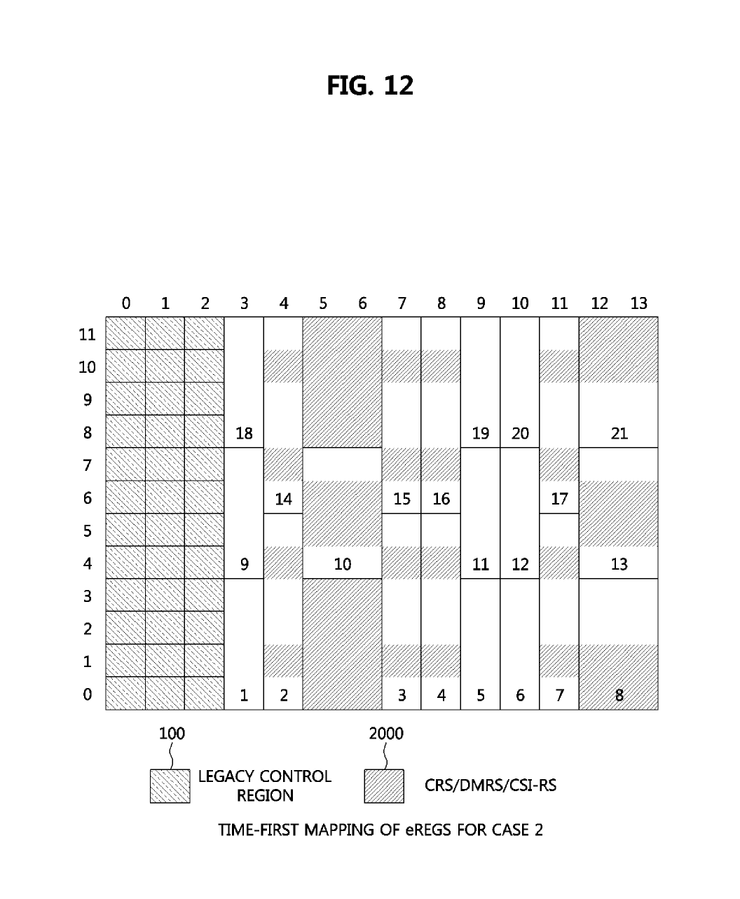

FIG. 12 is a view for explaining the concept of resource allocation in which eREGs are applied to case 2, according to another embodiment of the present invention;

The embodiment of FIG. 12 is the same as the embodiment of FIG. 11 in which a total of 21 eREG are used for ePDCCH, however, in the embodiment of FIG. 12, time-first mapping is applied.

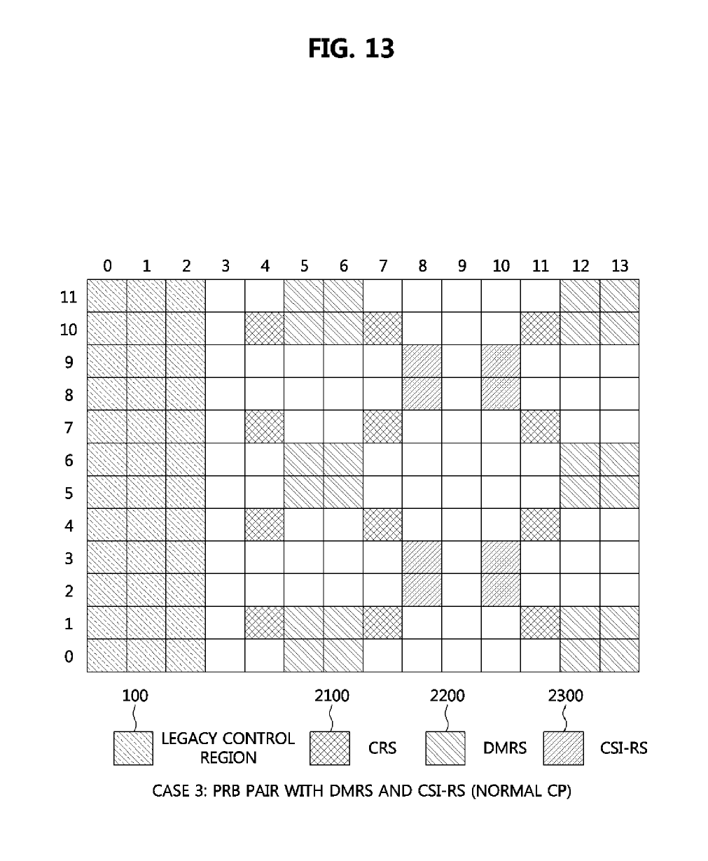

FIG. 13 shows a resource pattern to which ePDCCH is applied, according to another embodiment of the present invention, wherein CSI-RSs 2300 are positioned in OFDM symbols 8 and 10.

The case of FIG. 13 is referred to as case 3, in contrast with cases 1 and 2.

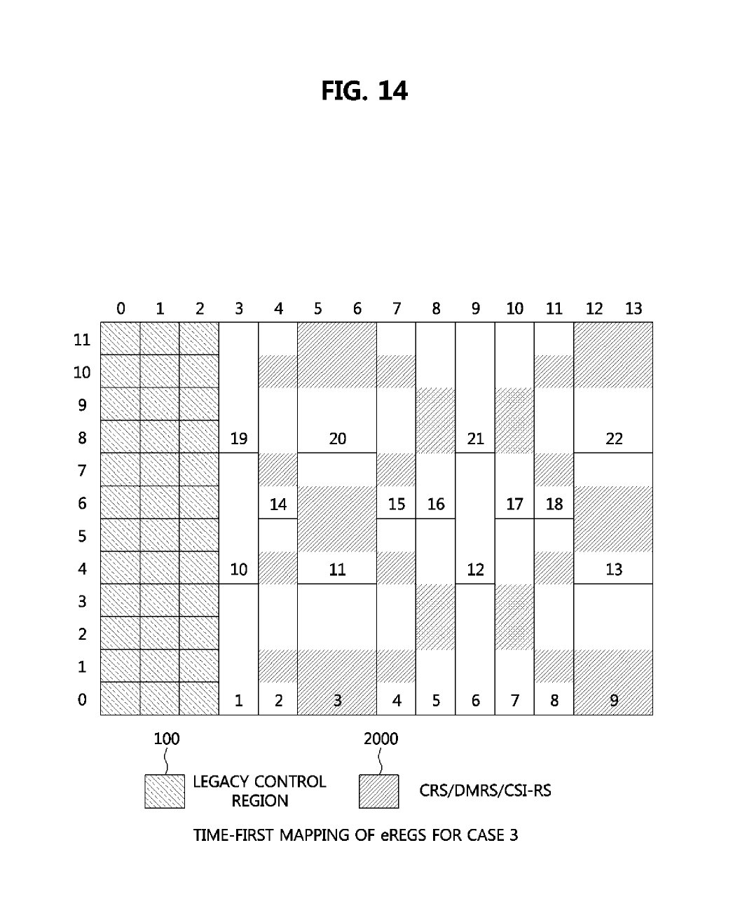

Resource allocation after applying eREGs to case 3 of FIG. 13 may be represented as shown in FIG. 14.

FIG. 14 is a view for explaining the concept of resource allocation in which eREGs are applied to case 3, according to an embodiment of the present invention.

eREGs as shown in case 1 are applied to symbols 5, 6, 12, and 13 of FIG. 14. The eREG pattern shown in (f) of FIG. 4 is applied to symbols 8 and 10. If the positions in frequency domain of CSI-RSs change, the eREG pattern shown in (e) or (g) of FIG. 4 may be used.

FIG. 14 shows the case in which a total of 22 eREGs are defined for case 3 and time-first mapping is used to set the order of resource allocation.

The embodiments of cases 1, 2, and 3, as described above, all relate to the normal CP, and cases 4, 5, and 6 which will be described below relate to embodiments in which 12 OFDM symbols are included in a pair of PRBs using an extended CP.

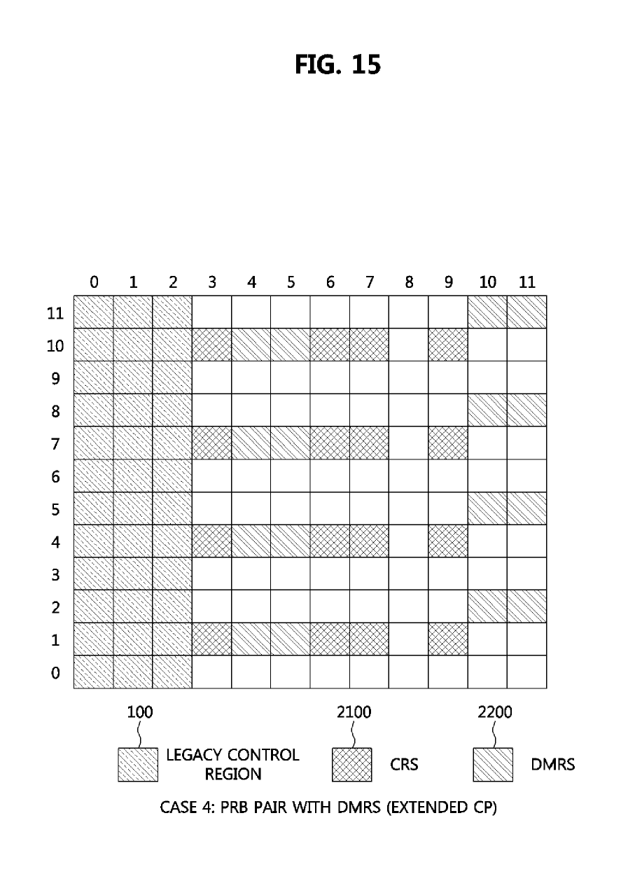

FIG. 15 shows a resource pattern to which an ePDCCH is applied according to an embodiment of the present invention, wherein an extended CP is used.

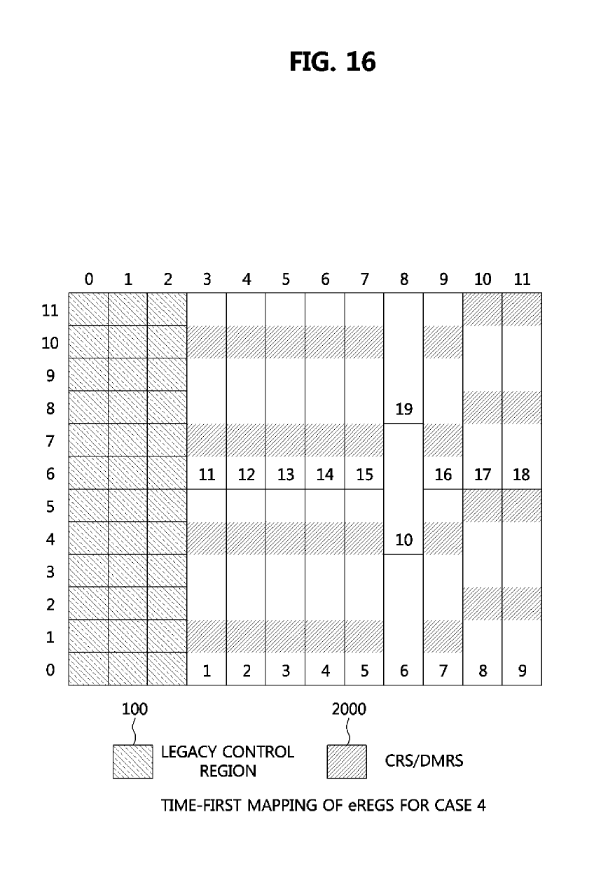

As shown in FIG. 15, the case in which CRSs 2100 and DMRSs 2200 are included in an ePDCCH region, and an extended CP is used is defined as case 4. In the case of the extended CP, only two antenna ports may be applied, and the patterns of resources used for DMRSs are also different from cases 1, 2, and 3. In cases 1, 2, and 3, the eREG patterns defined in FIG. 5 are applied to the DMRS patterns, but in case 4, the patterns shown in (c) and (d) of FIG. 4 are applied for resource allocation, which is shown in FIG. 16.

FIG. 16 is a view for explaining the concept of resource allocation in which eREGs are applied to case 4, according to an embodiment of the present invention;

In the embodiment of FIG. 16, time-first mapping is used, and by applying eREGs to case 4, a total of 19 eREGs are created.

In the embodiment of FIG. 16, the conventional REG concept has been applied, but the conventional REG patterns are included in eREGs. That is, in case 4, by applying different eREGs from those shown in FIG. 5 for REs with DMRSs, waste of resources may be prevented.

A greatest difference between the ePDCCH as described above and the legacy PDCCH is in that different patterns are applied according to cases. That is, since different patterns are applied for REs with DMRSs according to the pattern of DMRSs, waste of resources may be prevented.

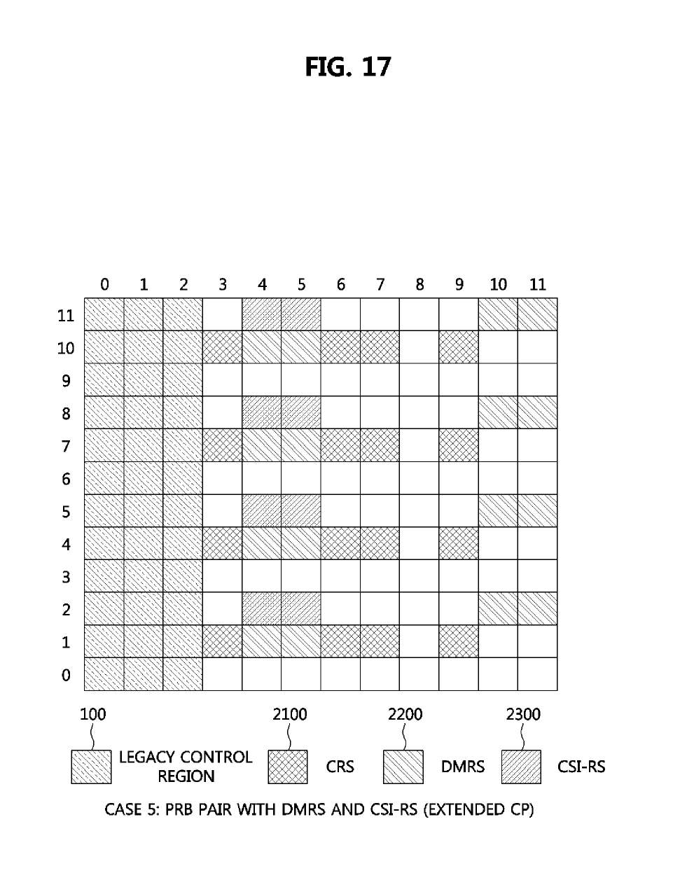

FIG. 17 shows a resource pattern to which ePDCCH is applied according to an embodiment of the present invention, wherein an extended CP is used.

FIG. 17 corresponds to the case in which CRSs, DMRS, and CSI-RSs are included in an ePDCCH region, and this case is defined as case 5.

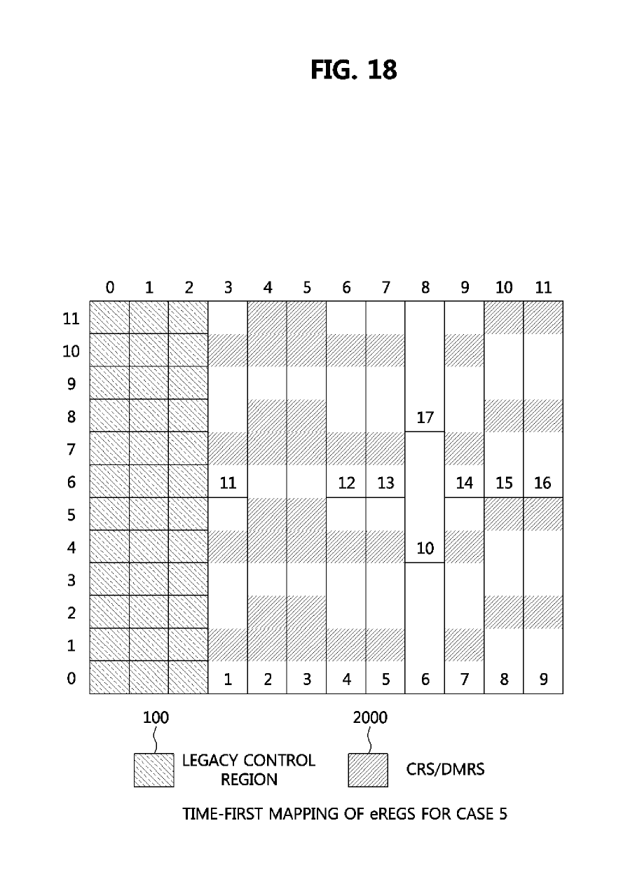

In case 5 shown in FIG. 17, a pattern (see FIG. 6) in which 12 REs are defined as an eREG may be applied to symbols 4 and 5, which is shown in FIG. 18.

FIG. 18 is a view for explaining the concept of resource allocation in which eREGs are applied to case 5, according to an embodiment of the present invention.

In the embodiment of FIG. 18, it is seen that an eREG is positioned in each of symbols 4 and 5. If the pattern defined in (a) of FIG. 6 is not applied to case 5, all REs of the symbols 4 and 5 will be wasted. In case 5, if the positions in frequency domain of the CSI-RSs change, the pattern shown in (b) of FIG. 6 may be used. The pattern shown in (c) of FIG. 6 may be applied when CSI-RSs are included in symbols 10 and 11.

In case 5 shown in FIG. 18, a total of 17 eREGs may be used, and the same REG pattern as in case 4 may be applied to the symbols 10 and 11.

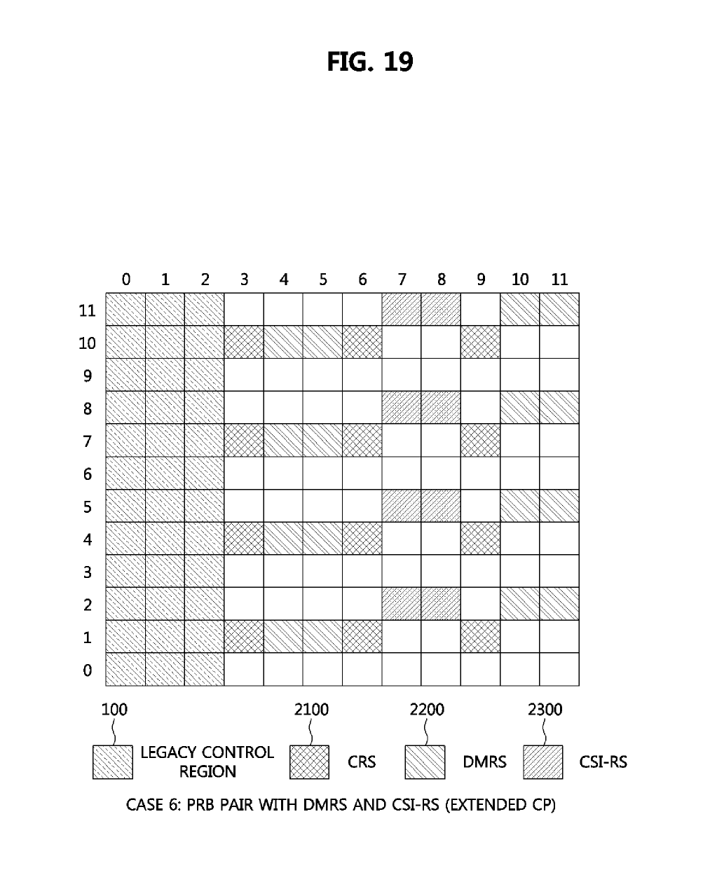

FIG. 19 shows a resource pattern to which an ePDCCH is applied according to another embodiment of the present invention, wherein an extended CP is used.

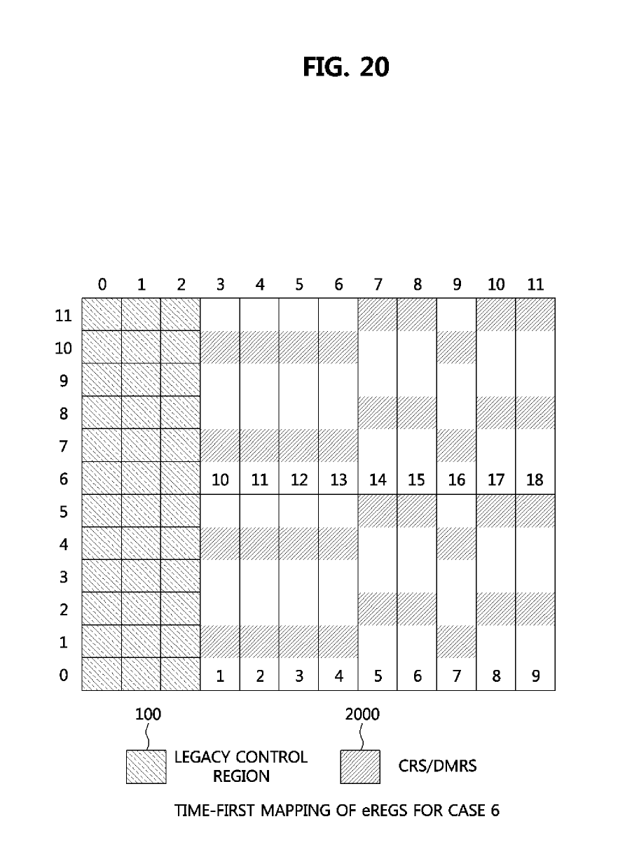

The embodiment of FIG. 19 corresponds to the case in which CSI-RSs are included in symbols 7 and 8, and this case is defined as case 6. Compared to case 4 of FIG. 15, embodiment of FIG. 19 is the case in which CSI-RSs are added to the symbols 7 and 8 and CSRs of the symbol 7 are removed. Compared to case 5, the embodiment of FIG. 19 is the case in which the positions of OFDM symbols in which CSI-RSs are included have changed, and an embodiment of resource allocation in the case of FIG. 19 is shown in FIG. 20.

FIG. 20 is a view for explaining the concept of resource allocation in which eREGs are applied to case 6, according to an embodiment of the present invention.

In the embodiment of FIG. 20, time-first mapping is applied, and 18 eREGs may be allocated.

eREGs have been defined above with reference to FIGS. 4, 5, and 6, and embodiments of time-frequency mapping of eREGs for cases having various CRSs, DMRSs, and CSI-RS patterns with respect to the eREGs defined in FIGS. 4, 5, and 6 have been described with reference to FIGS. 7 through 20.

Accordingly, when the conventional REG concept is applied, resources allocated to an ePDCCH may be wasted, but by introducing the concept of eREG, it is possible to apply an ePDCCH without causing waste of REs. Resource allocation for eREGs may be performed by various rules according to the lengths of CRSs, DMRSs, CSI-RSs, and CPs.

Hereinafter, rules under which eREGs are applied will be described.

When the legacy PDCCH is applied, it has been determined whether to apply REGs each configured with 4 REs or with 6 REs depending on presence/absence of CRSs in the corresponding OFDM symbol. However, when ePDCCH is applied, it is necessary to determine whether there are DMRSs and CSI-RSs, as well as CRSs, in the corresponding OFDM symbol.

FIG. 22 shows REGs for individual symbols, which can be applied when a normal CP is used in an FDD frame structure.

FIG. 22 is a table representing REGs for individual symbols, which can be applied when a normal CP is used in a frame structure based on an FDD scheme.

Referring to FIG. 22, 4, 6, and 8 REs may be selectively applied to each symbol, and 12 REs are applied to no OFDM symbol.

Details for the rule of applying REGs are as follows.
a) An REG configured with 4 REs is applied to symbols 2 and 3 having no RS.
b) An REG configured with 6 REs is applied to symbols 0, 4, 7, and 11 if there are CRSs for one or two TX antenna ports.
c) An REG configured with 6 REs is applied to symbol 1 if there are CRSs for four TX antenna ports, and otherwise, an REG configured with 4 REs is applied to the symbol 1.
d) An eREG configured with 8 REs is applied to symbols 5, 6, 12, and 13 in which there are only DMRSs or DMRSs and CSI-RSs.
e) An REG or eREG configured with 6 REs is applied to symbol 8 in which there are only CRSs or there may be CRSs and CSI-RSs. If there are neither CRSs nor CSI-RSs in the symbol 8, an REG configured with 4 REs is applied to the symbol 8.
f) An eREG configured with 6 REs is applied to symbols 9 and 10 in which there may be CSI-RSs. If there is no CSI-RS in the symbols 9 and 10, REG configured with 4 REs is applied to the symbols 9 and 10.

The table shown in FIG. 22 relates to FDD, and if a time domain duplex (TDD) scheme is used, the table should also be modified since the frame structure changes. For example, in the case of special subframe configurations 1, 2, 6, and 7 among the TDD scheme, OFDM symbols 2, 3, 5, and 6 include DMRSs. In the case of special subframe configurations 3, 4, and 8 among the TDD scheme, OFDM symbols 2, 3, 9, and 10 include DMRSs. In the remaining case, DMRSs are inserted into the same OFDM symbols as in the FDD scheme. Accordingly, in the TDD scheme, the numbers of OFDM symbols in which 8 REs configure an eREG change.

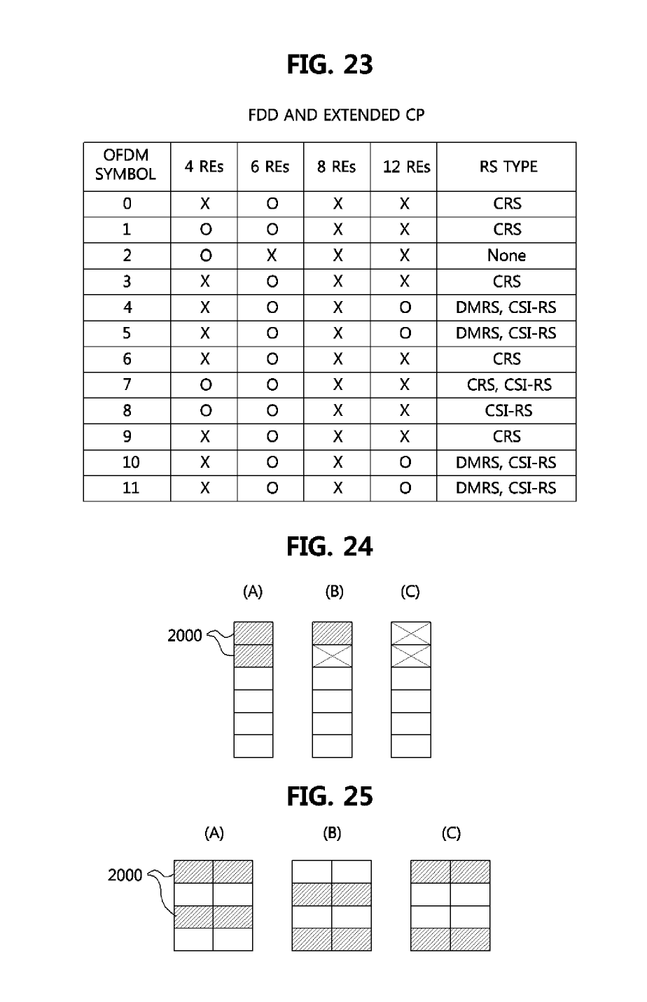

FIG. 23 shows REGs for individual symbols, which can be applied when an extended CP is used in an FDD frame structure.

FIG. 23 is a table representing REGs for individual symbols, which can be applied when an extended CP is used in a frame structure based on an FDD scheme. Unlike the normal CP, 8 REs are not applied. Instead, the case in which 12 REs are applied occurs.
a) An REG configured with 4 REs is applied to symbol 2 having no RS.
b) An REG configured with 6 REs is applied to symbols 0, 3, 6, and 9 since there are CRSs for one or two TX antenna ports
c) An REG configured with 6 REs is applied to symbol 1 if there are CRSs for 4 TX antenna ports, and otherwise, an REG configured with 4 REs is applied to the symbol 1.
d) Symbols 4, 5, 10, and 11 include only DMRSs or include DMRSs and CSI-RSs. If the symbols 4, 5, 10, and 11 include only DMRSs, an REG configured with 6 REs is applied to the symbols 4, 5, 10, and 11, and if the symbols 4, 5, 10, and 11 include DMRSs and CSI-RSs, an REG configured with 12 REs is applied to the symbols 4, 5, 10, and 11.
e) Symbol 7 includes CRSs or may include CSI-RSs, and an REG configured with 6 REs is applied to the symbol 7. If the symbol 7 includes neither CRSs nor CSI-RS, REG configured with 4 REs is applied to the symbol 7.
f) Symbol 8 may include CSI-RSs, and an REG configured with 6 REs is applied to the symbol 8. If there are neither CRSs nor CSI-RSs, REG configured with 4 REs is applied to the symbol 8.

The table shown in FIG. 23 relates to FDD, and if a TDD scheme is used, the table should also be modified since the frame structure changes. For example, in the case of special subframe configurations 1, 2, 3, 5, and 6 in the TDD scheme, only OFDM symbols 4 and 5 include DMRSs. In the remaining cases, DMRSs are inserted into the same OFDM symbols as in the FDD scheme. In the case of special subframe configurations 1, 2, 3, 5, and 6 in the TDD scheme, the configuration of an eREG with respect to symbols 10 and 11 depends on presence/absence of CSI-RSs. That is, if there is no CSI-RS, an REG configured with 4 REs is used, and if there are CSI-RSs, an REG configured with 6 REs is used.

What patterns of eREGs should be applied to individual OFDM symbols when a normal CP is used and when an extended CP is used, in an FDD frame structure, has been described. Also, a TDD frame structure having the different positions of DMRSs with respect to symbols from those of an FDD frame structure has been described above.

Hereinafter, resource allocation in an eREG will be described.

As described above, REGs configured with 4, 6, and 8 REs are used in the case of a normal CP, and REGs configured with 4, 6, and 12 are used in the case of an extended CP.

In the case of an REG configured with 4 REs, the 4 REs are in one-to-one correspondence with ePDCCH symbol quadruplets.

In the case of an REG configured with 6 REs, the remaining REs excluding 2 REs allocated to reference signals are in one-to-one correspondence with ePDCCH symbol quadruplets. In detail, in the case of an REG configured with 6 REs, one of (b) through (d) of FIG. 4 is used according to the positions of CRSs. In the case of an eREG configured with 6 REs, one of (e) through (g) of FIG. 4 is used according to the positions of CSI-RSs. The number of CSI-RS antenna ports can be 2, 4, or 8. If the number of CSI-RS antenna ports is 2 or 4, extra REs can be available in addition to 4 REs in the eREG which is shown in (e) through (g) of FIG. 4. Nevertheless, 8 antenna ports are assumed for matching REs in the eREG and a symbol quadruplet in the 6-RE case.

FIG. 24 shows various REG patterns according to antenna ports.

(a) of FIG. 24 is a pattern that can be created in the corresponding OFDM symbol when the number of CSI-RI antenna ports is 8, and (b) and (c) of FIG. 24 are patterns that can be created in the corresponding OFDM symbol when the number of CSI-RI antenna ports is 4 or less. According to the present disclosure, in the cases of (b) and (c) of FIG. 24, one or two RE resources may be additionally used, but the RE resources should be allocated as shown in (a) of FIG. 24. In this case, waste of available resources may occur more or less. However, this is a method for reducing complexity of implementation.

With regard to how to allocate ePDCCH symbols when the number of available REs is 4 in an REG configured with 8 REs, various methods can be considered. There is a method of first allocating the preceding OFDM symbol and then allocating the following OFDM symbol since an REG occupies two OFDM symbols. Another method is a method of first allocating two OFDM symbols to the same frequency and then performing allocation of a different frequency. Neither of the methods has a great influence on the performance.

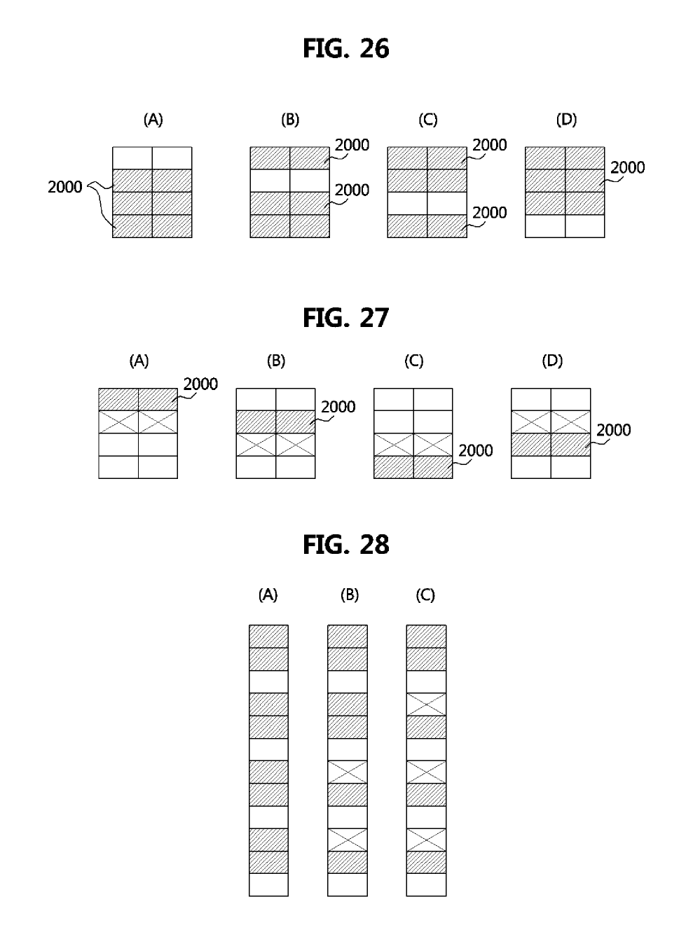

Various patterns other than the patterns shown in FIG. 5 may be created, which are shown in FIGS. 25 and 26.

FIG. 25 is a conceptual view of additional eREG patterns according to another embodiment of the present invention.

FIG. 25 shows three additional eREG patterns. The embodiment of FIG. 25 corresponds to the case in which two (antenna ports 7 and 8) of DMRS antenna ports are allocated, and two CSI-RS ports are allocated. In this case, since the number of available REs is 4, the REs are used as ePDCCH resources.

Meanwhile, the case in which the number of available REs among 8 REs is two may occur.

FIG. 26 shows additional eREG patterns according to another embodiment of the present invention.

The embodiment of FIG. 26 corresponds to the case in which the number of available REs among 8 REs is only two. As such, in the case in which the number of available REs among 8 REs is two, like (d) of FIG. 5, the two available REs are not used for ePDCCH resource allocation.

As another case, the case in which 6 REs among 8 REs are available may occur, which is shown in FIG. 27.

FIG. 27 shows additional eREG patterns according to another embodiment of the present invention, the case in which only DMRS antenna ports 7 and 8 are allocated is shown in (a) and (b) of FIG. 27, and the case in which only DMRS antenna ports 9 and 10 are allocated is shown in (c) and (d) of FIG. 27. In each case, if REs denoted by “X” are not used, the same allocation patterns as in FIG. 5 may be configured.

FIG. 28 shows resource allocation in eREGs each configured with 12 REs according to an embodiment of the present invention.

The eREGs each configured with 12 REs are used when the number of DMRS and CSI-RS antenna ports is 8 in an extended CP. In the case of (a) of FIG. 28, since the number of available REs is 4, the 4 REs are allocated for an ePDCCH. If the number of CSI-RS antenna ports is 2 or 4, 3 or 2 available REs are created in an eREG. In this case, a pattern shown in (a) of FIG. 28 is used for allocation without using regions denoted by “X” as shown in (b) and (c) of FIG. 28.

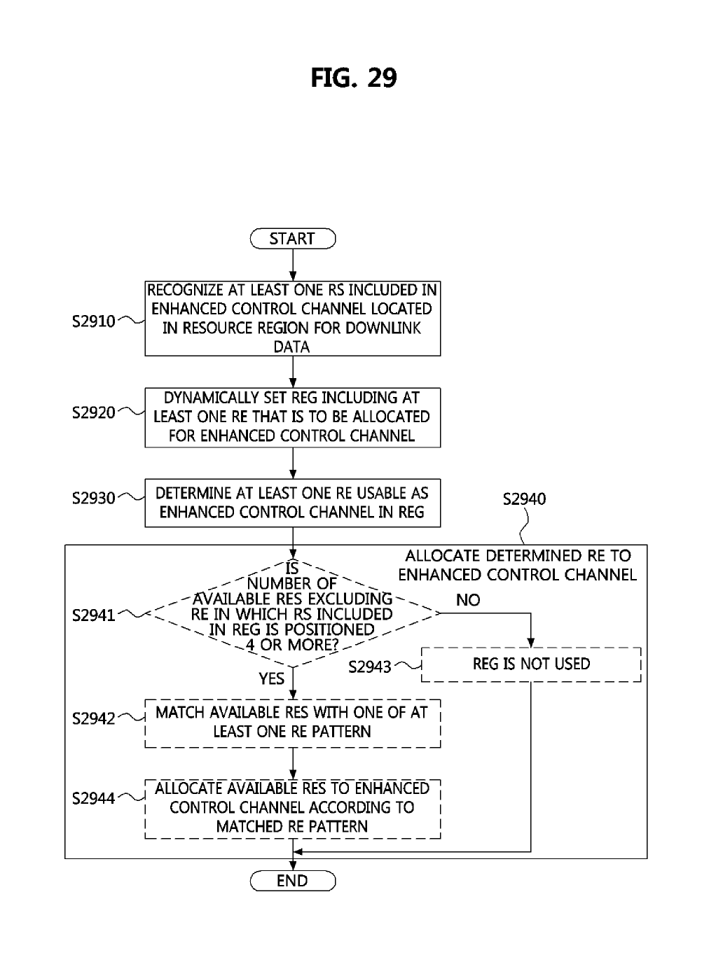

FIG. 29 is a flowchart showing a radio resource allocation method according to an embodiment of the present invention.

The radio resource allocation method shown in FIG. 29 may be performed by a base station.

The base station recognizes at least one RS included in an enhanced control channel located in a resource region for downlink data (S2910).

Then, the base station dynamically sets an REG including at least one RE that is to be allocated for the enhanced control channel, according to the RS (S2920). A method for dynamically setting an REG is to allocate REs included in an REG to an enhanced control channel depending on the numbers and positions of RSs included in the REG, in consideration of a CP that is used in the corresponding frame.

If a normal CP is used in a frame including an REG, the REG is configured to include 4, 6, or 8 REs. In this case, if the corresponding symbol includes a demodulation RS, an REG including 8 REs is set, and if the corresponding symbol includes an RS other than a demodulation RS, an REG including 4 or 6 REs is set.

Also, if an extended CP is used in a frame including an REG, the REG is configured to include 4, 6, or 12 REs. In this case, if the corresponding symbol includes a demodulation RS, an REG including 6 or 12 REs is set, and if the corresponding symbol includes a RS other than a demodulation RS, an REG including 4 or 6 REs is set.

Then, the base station determines at least one RE that can be used as the enhanced control channel among REs included in the set REG (S2930), and allocates the determined RE to the enhanced control channel (S2940).

Operation S2940 of allocating the RE to the enhanced control channel may include: operation S2941 of determining whether or not the number of available REs excluding an RE in which at least one RS included in an REG is positioned is 4 or more; operation S2942 of matching the available REs with one of at least one RE pattern if the number of the available REs is 4 or more; and operation S2944 of allocating the available REs to the enhanced control channel according to the matched RE pattern. Meanwhile, if the number of the available REs excluding the RE in which the at least one RS included in the REG is positioned is 3 or less, the corresponding REG is not used as an enhanced control channel (S2943).

Here, the at least one RE pattern includes a plurality of RE patterns included in various REG patterns shown in FIGS. 4, 5, and 6.

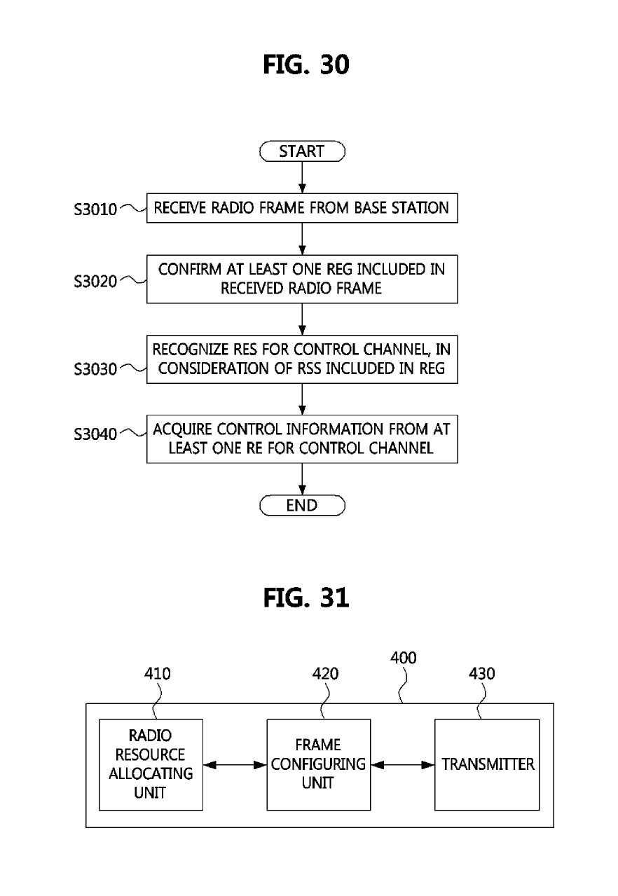

FIG. 30 is a flowchart showing a method in which a terminal receives control information, according to an embodiment of the present invention.

As described above, eREGs are applied to individual OFDM symbols in consideration of RSs, such as CRSs, DMRSs, CSI-RSs, etc., and the number of antenna ports. Also, the eREGs have structures that should be applied depending on the CP types and TDD/FDD. Since the terminal has recognized the structures through configuration information received from the upper layer, the terminal can know patterns that should be applied in advance. Accordingly, it is possible to effectively allocate resources to ePDCCH in a data region.

First, the terminal receives a radio frame transmitted from a base station (S3010), and defines at least one REG included in the received radio frame using configuration information acquired in advance (S3020).

Then, the terminal recognizes REs for a control channel, in consideration of RSs included in the REG (S3030), to thus acquire control information from at least one RE for the control channel (S3040).

The terminal (not shown) which performs the above-described operation includes a receiver for receiving a radio frame transmitted from a base station, and a controller for defining at least one REG included in the received radio frame, recognizing REs for a control channel in consideration of RSs included in the REG, and acquiring control information from at least one RE for a control channel.

FIG. 31 is a block diagram of a base station according to an embodiment of the present invention.

As shown in FIG. 31, the base station may include a radio resource allocating unit 410, a frame configuring unit 420, and a transmitter 430.

The radio resource allocating unit 410 recognizes at least one RS included in an enhanced control channel located in a resource region for downlink data, dynamically sets an REG including at least one RE that is to be allocated to the enhanced control channel according to the RS, determines at least one RE that can be used as an enhanced control channel among REs included in the set REG, and allocates the determined RE to the enhanced control channel.

Then, the frame configuring unit 420 configures a frame according to the allocated RE, and the transmitter 430 transmits the configured frame.

eREGs for effective resource allocation of an ePDCCH have been defined above according to various embodiments of the present invention. A conventional REG has been defined in units of 4 or 6 REs, however, the conventional REG cannot be used to effectively allocate most of resources since resource occupation by DMRSs and CSI-RSs has to be considered for eREG. That is, waste of resources becomes significant. Meanwhile, an eREG has various patterns in which REs are added in units of 8 and 12 REs to the conventional REG.

According to the present disclosure, since the concepts of CCE and aggregation level can be used by setting a basic unit for resource allocation to eREG, the concept used in the existing PDCCH may be reused.

While the example embodiments of the present invention and their advantages have been described in detail, it should be understood that various changes, substitutions and alterations may be made herein without departing from the scope of the invention.

What is claimed is:

1. A method of allocating radio resources in a mobile communication system, comprising:
recognizing one or more reference signals included in an enhanced control channel positioned in a resource region for downlink data;
dynamically setting a resource element group including one or more resource elements that are to be allocated to the enhanced control channel, according to the one or more reference signals; and
determining one or more resource elements available for the enhanced control channel among the resource elements included in the set resource element group, and allocating the one or more resource elements to the enhanced control channel.

2. The method of claim 1, wherein the resource element group includes 4, 6, 8, or 12 resource elements.

3. The method of claim 1, wherein the resource element group includes one or two orthogonal frequency division multiplexing (OFDM) symbols that are consecutive in a time domain.

4. The method of claim 1, wherein the reference signals include at least one signal among a cell-specific reference signal, a demodulation reference signal, and a channel state information-reference signal.

5. The method of claim 1, wherein dynamically setting the resource element group comprises allocating the resource elements included in the resource element group to the enhanced control channel depending on the numbers and positions of the reference signals included in the resource element group.

6. The method of claim 2, wherein, if a normal cyclic prefix (CP) is used in a frame in which the resource element group is included, the resource element group includes 4, 6, or 8 resource elements.

7. The method of claim 6, wherein dynamically setting the resource element group comprises setting a resource element group including 8 resource elements if a corresponding symbol includes a demodulation reference signal.

8. The method of claim 2, wherein, if a normal cyclic prefix (CP) is used in a frame in which the resource element group is included, the resource element group includes 4, 6, or 12 resource elements.

9. The method of claim 8, wherein a resource element group including 6 or 12 resource elements is set if a corresponding symbol includes a demodulation reference signal.

10. The method of claim 2, wherein dynamically setting the resource element group comprises setting a resource element group including 4 or 6 resource elements if a corresponding symbol includes a reference signal other than a demodulation reference signal.

11. The method of claim 2, wherein, if the resource element group includes 8 resource elements, the resource element group includes two symbols that are consecutive in a time domain.

12. The method of claim 2, wherein, if the resource element group includes 4, 6, or 12 resource elements, the resource element group includes one symbol in a time domain.

13. The method of claim 1, wherein determining the one or more resource elements available for the enhanced control channel and allocating the one or more resource elements to the enhanced control channel comprise:
matching, if the number of available resource elements excluding resource elements in which the one or more reference signals included in the resource element group are positioned is 4 or more, the available resource elements with a resource element pattern of one or more resource element patterns; and
allocating the available resource elements to the enhanced control channel according to the matched resource element pattern.

14. A base station comprising:
a radio resource allocating unit configured to recognize one or more reference signals included in an enhanced control channel positioned in a resource region for downlink data, to dynamically set a resource element group including one or more resource elements that are to be allocated to the enhanced control channel, according to the one or more reference signals, to determine one or more resource elements available for the enhanced control channel among the resource elements included in the set resource element group, and to allocate the one or more resource elements to the enhanced control channel;
a frame configuring unit configured to configure a frame according to the allocated resource elements; and
a radio transmitter configured to transmit the frame.

15. The base station of claim 14, wherein the radio resource allocating unit allocates the resource elements included in the resource element group to the enhanced control channel depending on the numbers and positions of the reference signals included in the resource element group.

16. A method in which a terminal receives control information from a base station, comprising:
receiving a radio frame transmitted from the base station;
defining at least one resource element group included in the radio frame;
recognizing one or more resource elements for a control channel, in consideration of one or more reference signals included in the resource element group; and
acquiring control information from the one or more resource elements for the control channel.

17. The method of claim 16, wherein the resource element group includes 4, 6, 8, or 12 resource elements.

18. The method of claim 16, wherein the resource element group includes one or two orthogonal frequency division multiplexing (OFDM) symbols that are consecutive in a time domain.
